(19) United States
(12) Patent Application Publication
(10) Pub. No.: US 2025/0229494 A1
(43) Pub. Date: Jul. 17, 2025

(54) SCANNER CALIBRATION FOR ADDITIVE MANUFACTURING IN A THREE DIMENSIONAL PRINTER INCORPORATING ZOOM OPTICS

(71) Applicant: nLIGHT, Inc., Camas, WA (US)

(72) Inventors: Aaron Brown, Vancouver, WA (US); Scott R. KARLSEN, Battle Ground, WA (US); Stefano ORIGLIA, Torino (IT); Giammarco ROSSI, Torino (IT)

(21) Appl. No.: 19/022,844

(22) Filed: Jan. 15, 2025

Related U.S. Application Data
(60) Provisional application No. 63/622,003, filed on Jan. 17, 2024.

(51) Int. Cl. B29C 64/393; B22F 10/31; B22F 12/45; B22F 12/49; B22F 12/90; B29C 64/135; B29C 64/153; B29C 64/268; B33Y 10/00; B33Y 50/02

(52) U.S. Cl. CPC B29C 64/393; B22F 10/31; B22F 12/45; B22F 12/49; B22F 12/90; B29C 64/268; B33Y 50/02; B29C 64/135; B29C 64/153; B33Y 10/00

(57) ABSTRACT

A method for calibrating a 3D printer includes adjusting, by a controller, the zoom optic to a first magnification. At the first magnification, a scanner reads a first position of a fiducial feature and a first impingement location of the laser beam on the first fiducial plane. Then, for the first magnification, the controller calculates a first drift from the first position of the fiducial feature to the first impingement location of the laser beam on the first fiducial plane. Subsequently, after adjusting the zoom optic to a second magnification, the scanner reads a second position of a fiducial feature and a second impingement location of the laser beam on the second fiducial plane. Then, for the second magnification, the controller calculates a second drift from the second position of the fiducial feature to the second impingement location of the laser beam on the second fiducial plane.

### CROSS-REFERENCE TO RELATED APPLICATION(S)

This United States Non-Provisional Patent Application relies for priority on and claims priority to U.S. Provisional Patent Application Ser. No. 63/622,003, filed on Jan. 17, 2024, the entire contents of which are incorporated herein by reference.

### Field of the Invention

The present disclosure relates to additive manufacturing. Embodiments encompass calibrations in laser systems used for additive manufacturing. More specifically, the present invention addresses calibration of laser systems that involve zoom optics that are incorporated into a three dimensional printer, where the zoom optics increase magnification along a Z-axis.

### BACKGROUND OF THE INVENTION

For three-dimensional (“3D”) laser printing, the prior art provides examples of how to calibrate a laser beam that is directed to a print medium to create a printed component.

The prior art does not provide a device and/or method that permits automated calibration of a laser beam that along a Z-axis.

### SUMMARY OF THE INVENTION

The present invention addresses one or more of the deficiencies in the prior art.

In one contemplated embodiment, the present invention provides a method for calibrating a 3D printer comprising a laser source adapted to generate a laser beam and direct the laser beam to a plurality of impingement locations on a fiducial plane, a plurality of fiducial features presented by the fiducial plane, a scanner adapted to scan the plurality of fiducial features and the plurality of impingement locations on the fiducial plane, a zoom optic adapted to change a magnification of the scanner, and a controller connected to the laser source, the scanner, and the zoom optic. The method begins by adjusting, by the controller, the zoom optic to a first magnification. At the first magnification, the scanner reads a first position of a fiducial feature and a first impingement location of the laser beam on the first fiducial plane. For the first magnification, the controller calculates a first drift from the first position of the fiducial feature to the first impingement location of the laser beam on the first fiducial plane. Then, the controller adjusts the zoom optic to a second magnification. At the second magnification, the scanner reads a second position of a fiducial feature and a second impingement location of the laser beam on the second fiducial plane. For the second magnification, the controller calculates a second drift from the second position of the fiducial feature to the second impingement location of the laser beam on the second fiducial plane.

In another contemplated embodiment, the controller fits a function between the first drift and the second drift.

It is also contemplated that the method encompasses an operation where, for the first magnification, the controller calculates the first drift for each first impingement location from the plurality of impingement locations and the second drift for each second impingement location from the plurality of impingement locations. If so, the controller is contemplated to fit a function between the first drift and the second drift for each impingement location from the plurality of impingement locations.

The method of the present invention also may include assessing, by the controller, if there is an Nth fiducial plane in addition to the first fiducial plane and the second fiducial plane. If so, the controller adjusts the zoom optic to an Nth magnification. At the Nth magnification, the scanner reads an Nth position of a fiducial feature and an Nth impingement location of the laser beam on the Nth fiducial plane. In addition, for the Nth magnification, the controller calculates an Nth drift from the Nth position of the first fiducial feature to the Nth impingement location of the laser beam on the Nth fiducial plane.

For the embodiment with an Nth fiducial plane, the method may include fitting, by the controller, a function between the first drift, the second drift, and the Nth drift.

In another contemplated embodiment, the method includes, for the first magnification, calculating, by the controller, the first drift for each first impingement location from the plurality of impingement locations, for the second magnification, calculating, by the controller, the second drift for each second impingement location from the plurality of impingement locations, and for the Nth magnification, calculating, by the controller, the Nth drift for each Nth impingement location from the plurality of impingement locations. In this embodiment, the method also may include fitting, by the controller, a function between the first drift, the second drift, and the Nth drift for each impingement location from the plurality of impingement locations.

It is contemplated that the magnification is between 1× and 3×.

Other features and advantages of the present invention will be made apparent from the discussion that follows.

### BRIEF DESCRIPTION OF THE DRAWINGS

The present invention is described in connection with the drawing appended hereto, in which:

FIG. 1 is a graphical, side view of a 3D printer according to the present invention, shown at a time after the deposition of a first layer of print medium on a print bed thereof, with an optical zoom of 1×;

FIG. 2 is a graphical, side view of the 3D printer illustrated in FIG. 1, shown at a time when an interactive laser beam is projected onto the first layer of the print medium, with an optical zoom of 1×;

FIG. 3 is a graphical, side view of the 3D printer illustrated in FIG. 1, shown at a time after the creation of a portion of a printed component from the first layer of the print medium, with an optical zoom of 1×;

FIG. 4 is a graphical, side view of the 3D printer illustrated in FIG. 1, shown at a time after the deposition of a second layer of the print medium atop the first layer, with an optical zoom of 1×, and at a time when a calibration template has been introduced above the second layer;

FIG. 5 is a graphical, side view of the 3D printer illustrated in FIG. 1, shown at a time when the interactive laser beam is projected onto the second layer of the print medium, with an optical zoom of 1×;

FIG. 6 is a graphical, side view of the 3D printer illustrated in FIG. 1, shown at a time after the creation of a portion of a printed component from the second layer of the print medium, with an optical zoom of 1×;

FIG. 7 is a graphical representation of a calibration template used for a scanner calibration routine known in the prior art;

FIG. 8 is a graphical representation of another calibration template used according to a separate calibration process known to the prior art;

FIG. 9 is a graphical representation of a prior art scan across a fiducial feature to enable determination of the location of the fiducial feature;

FIG. 10 is a graphical representation of the locations of fiducial features on a calibration template at three different optical zooms;

FIG. 11 is a graphical representation of the impingement locations of the projection of a laser beam onto the calibration template at the three optical zooms illustrated in FIG. 10;

FIG. 12 is an illustration of a first portion of a method for calculating drift of a laser beam at various magnifications;

FIG. 13 is an illustration of a second portion of the method for calculating drift of a laser beam at various magnifications;

FIG. 14 is an illustration of a third portion of the method for calculating drift of a laser beam at various magnifications; and

FIG. 15 is an illustration of a fourth portion of the method for calculating drift of a laser beam at various magnifications.

### DETAILED DESCRIPTION OF EMBODIMENT(S) OF THE INVENTION

The present invention will now be described in connection with several examples and embodiments. The present invention should not be understood to be limited solely to the examples and embodiments discussed. To the contrary, the discussion of selected examples and embodiments is intended to underscore the breadth and scope of the present invention, without limitation. As should be apparent to those skilled in the art, variations and equivalents of the described examples and embodiments may be employed without departing from the scope of the present invention.

In addition, aspects of the present invention will be discussed in connection with specific materials and/or components. Those materials and/or components are not intended to limit the scope of the present invention. As should be apparent to those skilled in the art, alternative materials and/or components may be employed without departing from the scope of the present invention.

In the illustrations appended hereto, for convenience and brevity, the same reference numbers are used to refer to like features in the various examples and embodiments of the present invention. The use of the same reference numbers for the same or similar structures and features is not intended to convey that each element with the same reference number is identical to all other elements with the same reference number. To the contrary, the elements may vary from one embodiment to another without departing from the scope of the present invention.

Still further, in the discussion that follows, the terms “first,” “second,” “third,” etc., may be used to refer to like elements. These terms are employed to distinguish like elements from similar examples of the same elements. For example, one fastener may be designated as a “first” fastener to differentiate that fastener from another fastener, which may be designated as a “second fastener.” The terms “first,” “second,” “third,” are not intended to convey any particular hierarchy between the elements so designated.

It is noted that the use of “first,” “second,” and “third,” etc., is intended to follow common grammatical convention. As such, while a component may be designated as “first” in one instance, that same component may be referred to as “second, “third,” etc., in a separate instance. The use of “first,” “second,” and “third,” etc., therefore, is not intended to limit the present invention.

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items. The systems, apparatus, and methods described herein should not be construed as limiting in any way. Instead, the present disclosure is directed toward all novel and non-obvious features and aspects of the various disclosed embodiments, alone and in various combinations and sub-combinations with one another. The term “or” refers to “and/or,” not “exclusive or” (unless specifically indicated).

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation. Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatuses.

Additionally, the description sometimes uses terms like “produce” and “provide” to describe the disclosed methods. These terms are high level abstractions of the actual operations that are performed. The actual operations that correspond to these terms will vary depending on the particular implementation and are readily discernible by one of ordinary skill in the art. In some examples, values, procedures, or apparatuses are referred to as “lowest,” “best,” “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

Scanner calibration within known three-dimensional powder bed fusion (“3D PBF”) printing systems may be performed between build cycles, and may require the assessment of a sample piece that is inserted into and removed from the machine to evaluate calibration quality. Depending on methodology, the temporary item may or may not require additional analysis outside of the machine to complete the calibration process.

Manually adding a temporary item into a chamber to assess scanner calibration significantly affects a user's ability to perform a calibration during the build of a part, and therefore limits the frequency of calibration.

Since build cycles can typically take many days, build processes may depend on the machinery maintaining calibration without verification. A lack of calibration verification during long build cycles presents a risk to the parts being produced and requires very robust mechanical structures that increase the overall cost and complexity of the 3D printing machine.

The present invention addresses, among other things, a need for periodic calibration of 3D printing machines, especially when the 3D printing machine is used for a long duration and/or complex manufacturing process.

In various embodiments described herein, a calibration process may be performed during the build process. This may help ensure scanner accuracy over long periods of time and may reduce the risk of building parts that are out-of-spec.

The present invention also incorporates a zoom optic. The present invention provides a method for estimating drift of a laser beam from calibration positions at various magnifications of the zoom optic. For purposes of the present invention, the deviation of the laser beam from an ideal location is referred to herein as “drift.” Other terms are equally applicable, such as “error,” “deviation,” etc. While the term “drift” is employed herein, it is noted that the term is not intended to suggest only an environment where the deviation or error is dynamically changing. To the contrary, the term “drift” is intended to capture instances where the deviation and/or error is static and/or dynamic.

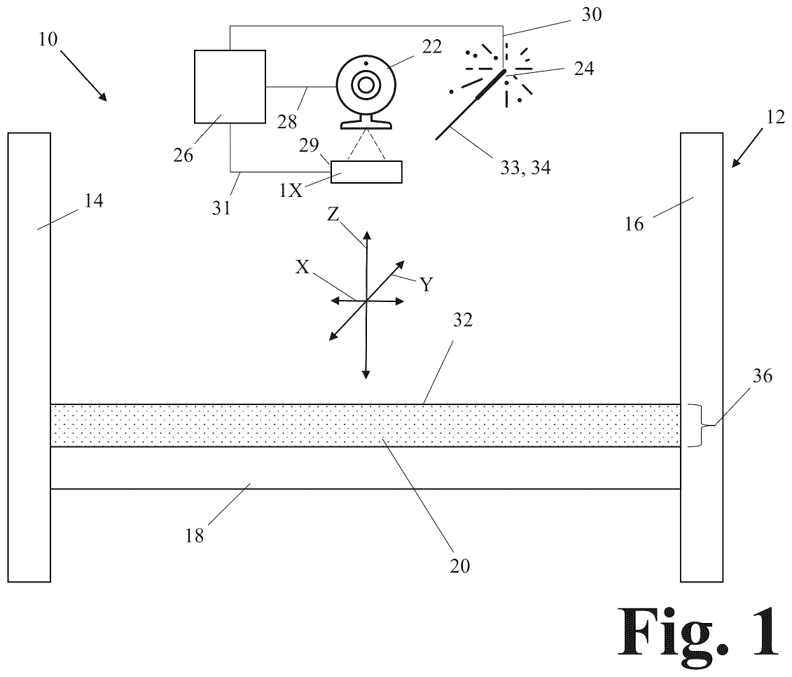

The present invention encompasses a three-dimensional printer 10 (3D printer 10), the operation of which is discussed in connection with FIGS. 1-6.

FIG. 1 is a graphical representation of a 3D printer according to the present invention. The 3D printer 10 is illustrated in a vertical cross-section.

The 3D printer 10 includes a print enclosure 12. The print enclosure 12 has walls 14, 16 that surround a print bed 18. A print medium 20 is deposited on the print bed 18 and is retained in the print enclosure 12 by the walls 14, 16.

It is noted that the size and shape of the enclosure 12 and the print bed 18 are not relevant to the present invention. The present invention is contemplated to be applicable to the manufacture of small parts, such as a valve, to larger components, such as a rocket engine.

The print medium 20 may be any material suitable for additive manufacturing, as should be apparent to those skilled in the art. The print medium 20 may be, for example, powdered metal including, but not limited to iron, aluminum, titanium, copper, zirconium, magnesium, alloys thereof, and combinations thereof.

To simplify the instant discussion, the present invention is described in connection with the use of a metal powder as a non-limiting example of the print medium 20. While the 3D printer 10 is described in this fashion, it is noted that the present invention is not limited to the use of metal powder. Other print media 20 are contemplated to fall within the scope of the present invention. For example, the 3D printer may fashion components from resin and/or plastic powder. Still further, the present invention is contemplated to be applicable to 3D printers 10 that employ a liquid, such as a liquid resin, as the print medium 20 instead of a powder. The print medium 20 also may be a combination of liquid and solid materials, as may be required and/or desired.

The 3D printer 10 includes a scanner 22, a laser source 24, and a controller 26. The scanner 22 is connected to the controller 26 via a first communication link 28. The laser source 24 is connected to the controller via a second communication link 30.

The 3D printer 10 also includes a zoom optic 29 that is connected to the controller 26 via a third communication link 31. As discussed in greater detail herein below, the zoom optic 29 may combine any number of optical components that permit the controller to provide a magnification (or zoom) functionality for the 3D printer 10, specifically for the scanner 22. The zoom optic 29 provides magnification in the Z-axis direction, which is indicated in FIG. 1.

In FIGS. 1-6, to simplify the discussion of the operation of the present invention, the magnification of the zoom optic 29 is at 1× (or one times) magnification.

For one embodiment of the present invention, the zoom optic 29 is contemplated to provide magnification from 1× to 3× during normal operation. In many instances, the magnification is contemplated to be within 1× to 2×.

To effectuate a zoom function, the zoom optic 29 may include a lens and/or a combination of lenses, the exact construction of which should be understood by those skilled in the art. The optical composition of the zoom optic 29 is not critical to the operation of the 3D printer 10 of the present invention.

The scanner 22 is contemplated to be a camera that detects light within the print enclosure 12 at a position on or near to the surface 32 of the print medium 20. It is contemplated that the light may be provided by an ambient light source, as should be apparent to those skilled in the art. Separately, the scanner 22 may emit light that the scanner 22 detects.

In the contemplated embodiment of the 3D printer 10 of the present invention, the laser source 24 is contemplated to provide the illumination for the scanner 22. Specifically, the laser source 24 is contemplated to emit laser light that does not affect the print medium 20 but is of a sufficient intensity to be detected by the scanner 22. Without limiting the present invention, the laser source 24 may emit light of a low intensity such that the laser light does not affect the print medium 20. Alternatively, the laser light may be of a particular frequency that does not affect the print medium 20. For example, the light may have a frequency in the infra red or ultra violet portions of the electromagnetic spectrum.

In the paragraphs that follow, the scanner 22 will be described as a camera or a light detector (e.g., a photodiode or several photodiodes). However, the discussion of the scanner 22 as a camera or as a light detector should not be understood to limit the scope of the present invention. The present invention is contemplated to encompass any of a wide variety of types of scanners 22 without limitation.

The laser source 24 may be of any type capable of two functions. First, the laser source 24 is contemplated to emit a laser beam 33 that may be reflected from a position on or near the print medium 20 without altering the print medium 20. The reflected light is detected by the scanner 22. For clarity, the laser beam 33 also referred to herein as a non-interactive laser beam 33, meaning that the laser beam 33 does not interact with the print medium 20. Second, the laser source 24 is contemplated to emit a laser beam 34 with sufficient intensity that the laser beam 34 alters the print medium 20 to create a printed product PC, as discussed in greater detail hereinbelow. This is also referred to as an interactive laser beam 34, because the laser beam 34 changes the properties of the print medium 20.

For clarity, the non-interactive laser beam 33 need not be of a type that has no interaction with the print medium 20. For purposes of the present invention, the term “non-interactive” means that the laser light does not alter the properties of the print medium 20 so as to produce a portion of a printed component PC.

It is noted that the laser source 24 may be a single laser generator that is capable of generating both the non-interactive laser beam 33 and the interactive laser beam 34. Alternatively, the laser source 24 may incorporate two separate laser beam generators, one for the non-interactive laser beam 33 and one for the interactive laser beam 34. Still further, the laser source 24 may generate only the interactive laser beam 34, but also incorporate an optic device that dims the intensity of the interactive laser beam 34 to create the non-interactive laser beam 33. As should be apparent to those skilled in the art, the laser source 24 may have any number of configurations to generate the non-interactive laser beam 33 and the interactive laser beam 34. The present invention is not considered to be limited to any one particular configuration.

The controller 26 may be any suitable computing device that is capable of receiving input data and executing instructions to operate the 3D printer 10. The controller 26 is contemplated to receive input from the scanner 22, to process that input, and to provide instructions to direct the laser beam 33, 34 generated by the laser source 24 onto the surface 32 of the print material 20.

The first communication link 28 connects the scanner to the controller 26. The first communication link 28 is contemplated to be a bi-directional link to provide electronic signals from the scanner 22 to the controller 26 and vice-versa. However, the first communication link 28 may be unidirectional without departing from the scope of the present invention.

The second communication link 30 connects the laser source 24 to the controller 26. The second communication link 30 also is contemplated to be a bi-directional link to provide electronic signals from the laser source 24 to the controller 26 and vice-versa. However, the second communication link 30 may be unidirectional without departing from the scope of the present invention.

The third communication link 31 connects the zoom optic 29 to the controller 26. The third communication link 31 also is contemplated to be a bi-directional link to provide electronic signals from the zoom optic 29 to the controller 26 and vice-versa. However, the third communication link 31 may be unidirectional without departing from the scope of the present invention.

The first communication link 28, the second communication link 30, and the third communication link 31 are contemplated to be wired links to the controller 26. However, these communication links 28, 30, 31 may be wireless without departing from the scope of the present invention. Moreover, these communication links 28, 30, 31 may combine wired and wireless components, as should be apparent to those skilled in the art.

As illustrated in FIG. 1, the print enclosure 12 has been provided with a first layer 36 of the print material on the print bed 18. The first layer 36 of the print material 20 is contemplated to be a thin layer, with a surface 32, that is appropriate for the manufacture of the printed component PC.

FIG. 1 illustrates the 3D printer 10 before a first application of the interactive laser beam 34 to the print material 20. In this illustration, the print material 20 is entirely in powdered (or liquid) form, as appropriate for manufacturing the printed component PC.

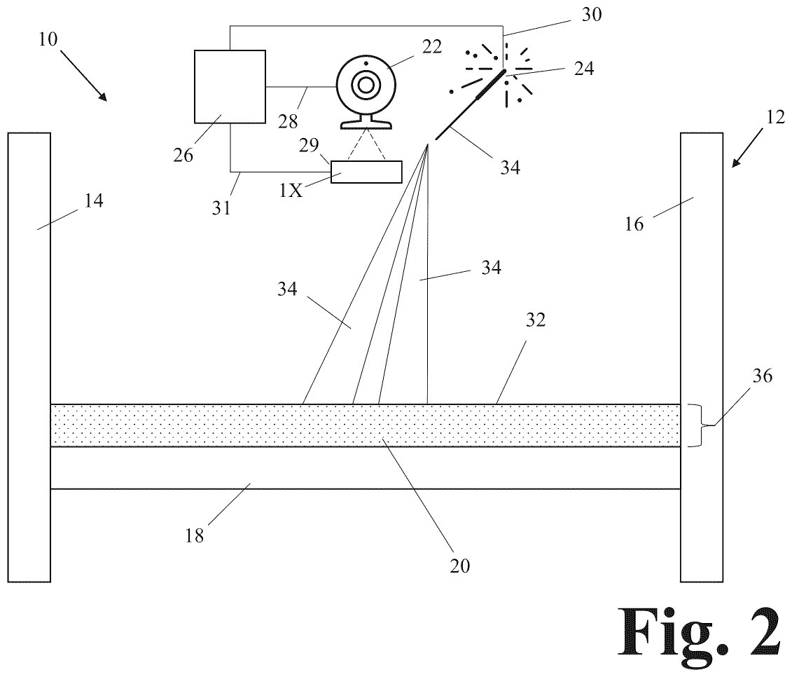

FIG. 2 is a vertical cross-section of the 3D printer 10 illustrated in FIG. 1.

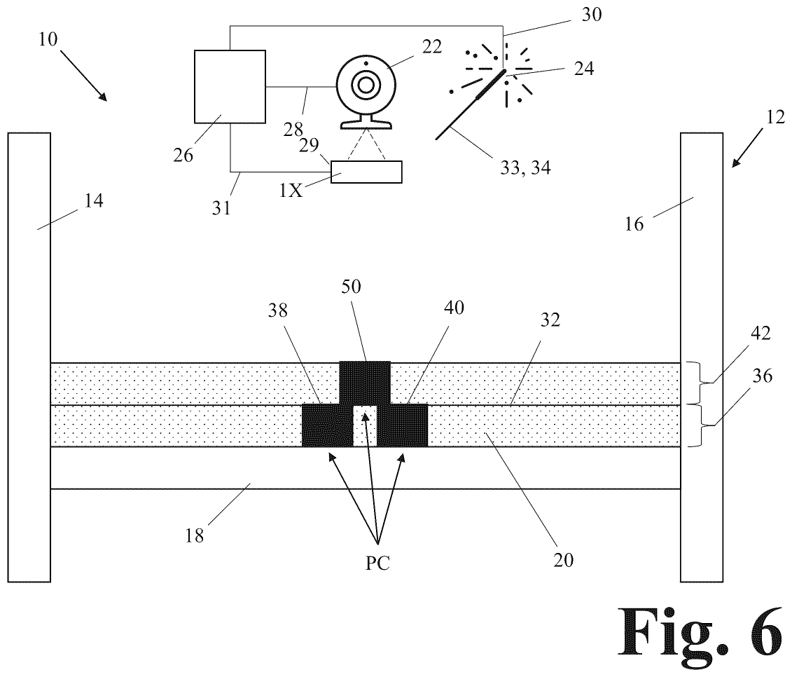

In FIG. 2, the laser source 24 has been activated by the controller 26 to direct the interactive laser beam 34 to the print medium 20. The interactive laser beam 34 causes the print medium 20 to consolidate and form one layer of the printed component PC, which is shown in FIG. 6.

In the case, as here, where the print medium 20 is a powdered metal, the interactive laser beam 34 melts the powdered metal to form a molten material. The molten material then solidifies to consolidate and form a portion of the printed component PC. Specifically, the molten material solidifies to form one layer of the printed component PC.

As should be apparent from FIG. 2, the interactive laser beam 34 impinges on the first layer 36 of the print medium 20.

FIG. 2 illustrates a point in time after the condition of the 3D printer as shown in FIG. 1.

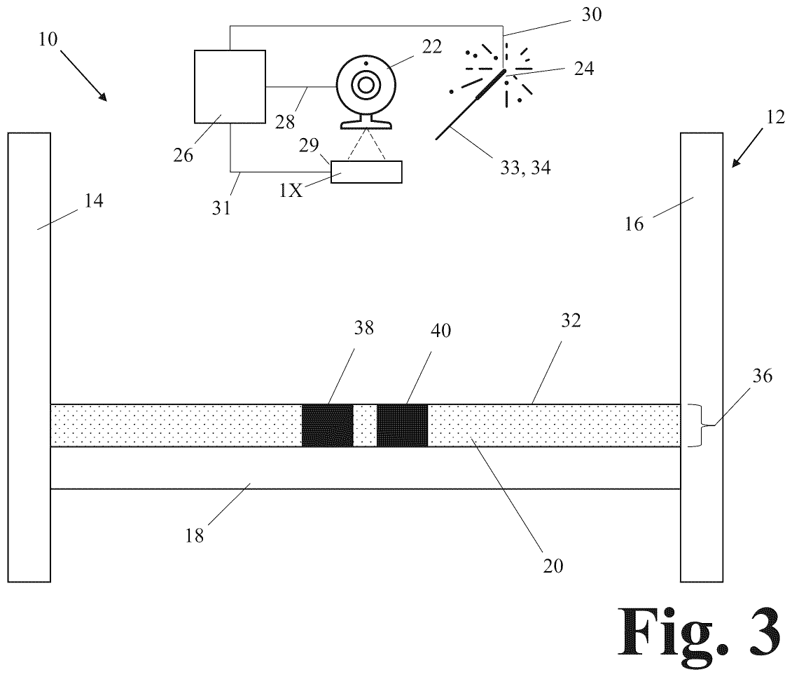

FIG. 3 is a vertical cross-section of the 3D printer illustrated in FIG. 1.

FIG. 3 illustrates a point in time after the interactive laser beam 34 is deactivated, following the operation illustrated in FIG. 2.

In particular, FIG. 3 illustrates the state after the interactive laser beam 34 is deactivated, and the printed material 20 has solidified into a first portion 38 of the printed component PC and a second portion 40 of the printed component PC. As illustrated, the print medium 20 on which the interactive laser beam 34 was not focused remains unaffected. In other words, where the printed medium 20 is a powdered metal, the portions of the print medium 20 not impacted by the interactive laser beam 34 remain as powdered metal.

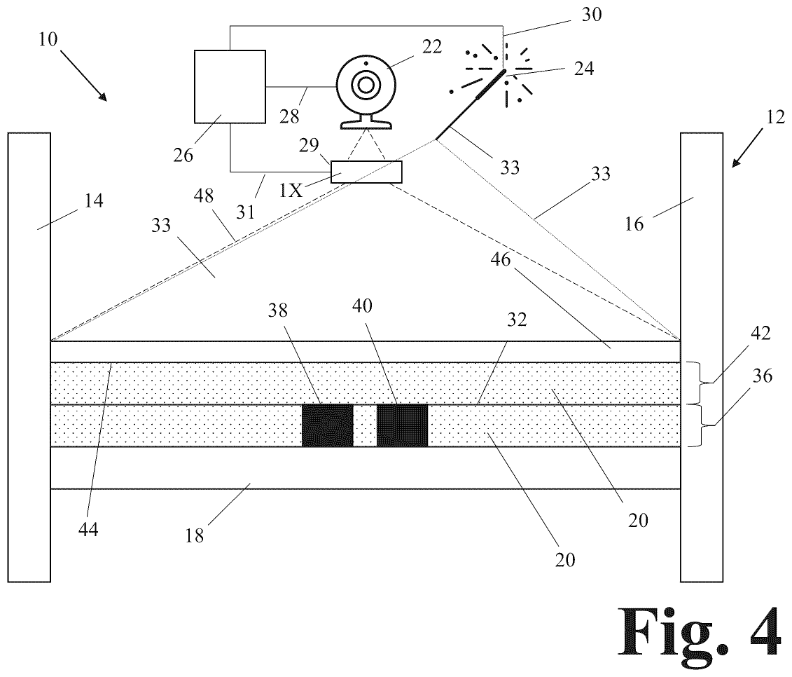

FIG. 4 is a vertical cross-section of the 3D printer illustrated in FIG. 1.

FIG. 4 illustrates a moment after a second layer 42 of the print medium 20 has been deposited onto the first layer 36. The second layer 42 of the print medium 20 has a surface 44.

In FIG. 4, a calibration template 46 has been introduced between the scanner 22 and the second layer 42 of the print medium 20. Details of the calibration template 46 are provided below.

The calibration template 46 introduces a fiducial pattern that, when illuminated by the laser source 24 using the non-interactive laser light 33, permits detection, by the scanner 22, of a fiducial pattern that is used by the controller 26 to direct the interactive laser beam 34 onto the print medium 20. The calibration template 46 permits the controller 26 to adjust the location(s) where the interactive laser beam 34 strikes the print medium 20. In other words, the calibration template 46 permits the controller 26 to adjust for any drift of the laser beam 33, 34 from the locations identified by the fiducial pattern.

In FIG. 4, the calibration template 46 is positioned between the scanner 22 and the second layer 42 of the print medium 20. Here, the scanner 22 has been activated, as indicated by the illustration of the scanner region 48.

The non-interactive laser beam 33 has been activated to illuminate the calibration template 46. The scanner 22 detects light reflected from (or absorbed by) the calibration template 46 (i.e., the fiducial features, discussed below) to assess if the non-interactive laser light 33 is in register with the fiducial features. In this manner, the controller 26 may make calibration adjustments to the focusing of the interactive laser light 34 to assure that the interactive laser light 34 is directed to the correct location(s) on the print medium 20.

In summary, FIG. 4 illustrates a calibration stage in the operation of the 3D printer 10.

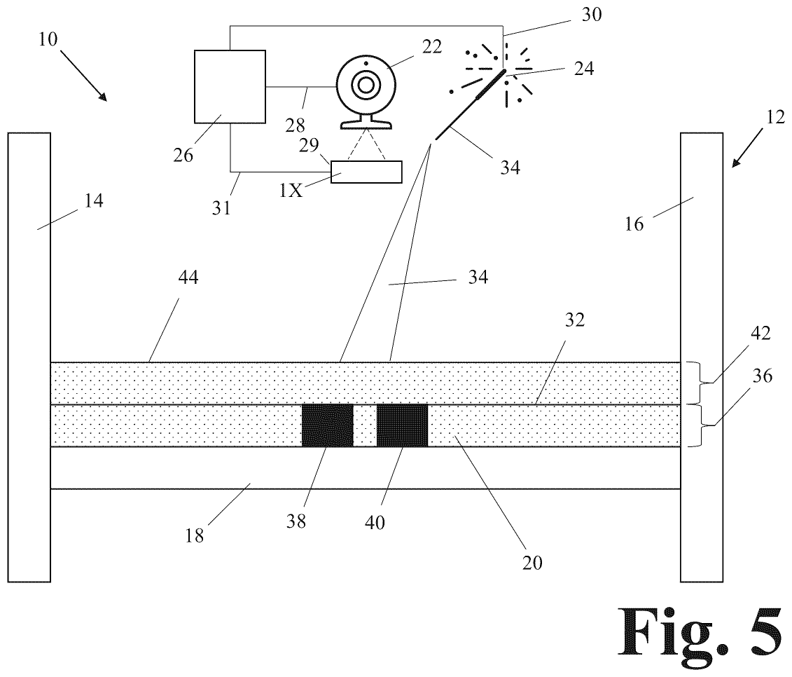

FIG. 5 is a vertical cross-section of the 3D printer 10 illustrated in FIG. 1.

FIG. 5 depicts the operation of the 3D printer 10 after calibration adjustments have been made by the controller 26.

In FIG. 5, the laser source 24 has been activated a second time by the controller 26 to direct the interactive laser beam 34 onto the print medium 20. In this illustration, the calibration template 46 has been removed, and the interactive laser beam 34 is being directed to the surface 44 of the second layer 42.

As before, the interaction between the interactive laser light 34 and the print medium 20 causes the properties of the print medium 20 to change, thereby forming another portion of the printed component PC.

FIG. 6 is a vertical cross-section of the 3D printer 10 illustrated in FIG. 1.

Following the application of the interactive laser light 34, at a point in time after the print medium (e.g., the powdered metal) melts 20 and solidifies, a third portion 50 of the printed component PC is formed in the second layer 42 of the print medium 20.

In FIG. 6, the printed component PC is illustrated as the combination of the first portion 38, the second portion 40, and the third portion 50. In this simplified depiction of the operation of the 3D printer 10, the printed component PC contains three portions, the first portion 38, the second portion 40, and the third portion 50. As should be apparent to those skilled in the art, the printing of a printed component PC may involve hundreds or thousands of individual layers of printed medium.

After the third portion 50 is printed, as illustrated in FIG. 6, additional, successive layers of the print medium 20 may deposited and altered by the interactive laser beam 34. The calibration template 46 may be inserted into the 3D printer 10, as illustrated in FIG. 4, periodically during the additive manufacturing process. For example, the calibration template 46 may be inserted after each application of the interactive laser beam 34 to the print medium 20. Alternatively, the calibration template 46 may be inserted at predetermined intervals, as deemed appropriate for the particular printed component PC and the calibration drift experienced for the 3D printer 10.

The process of additive manufacturing illustrated in FIGS. 1-6 is repeated until the printed component PC is complete.

The present invention addresses one potential issue that may arise when printing a printed component PC. Specifically, as identified above, when the laser beam 34 is applied to successive layers of the print medium 20, it is possible for the laser beam 34 to deviate, or “drift,” from the position required to print the printed component PC. To correct any deviations of the laser beam 34 from ideal locations, it is necessary to calibrate the operation of the laser source 24 periodically so that the interactive laser beam 34 is focused on the correct location(s) on the print medium 20.

As discussed in greater detail below, calibration is accomplished via periodic use of the calibration template 46 or different versions of the calibration template 46 as discussed herein.

The present invention differs from the prior art in many ways from the prior art. Among the differences, the present invention incorporates automated calibration for the laser source 24.

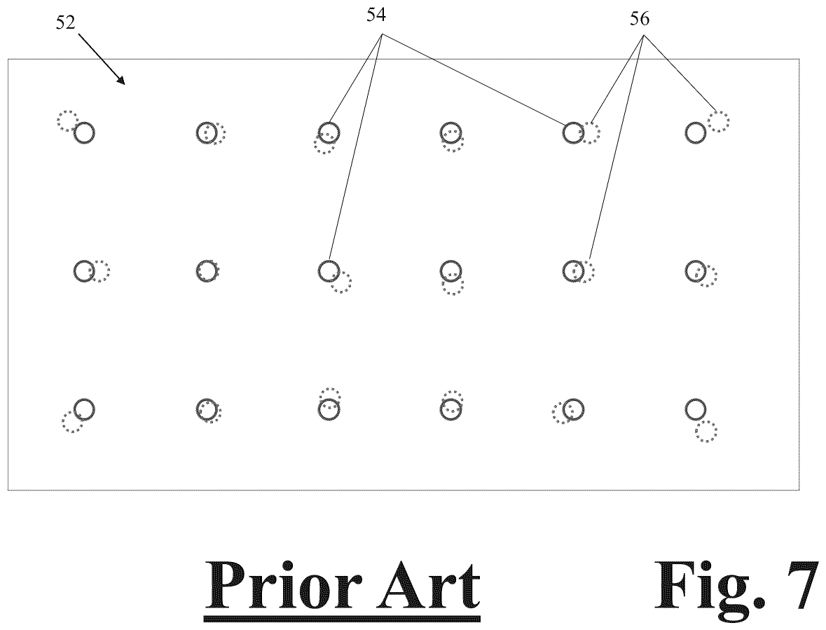

Before discussing the calibration provided by the present invention, a brief overview of prior art calibration is discussed in connection with FIGS. 7-9.

In the prior art, it is known that a scanner calibration routine may be employed to ensure that the commanded beam location is the same as (or very close to) the actual beam location across the whole scan field. Some prior art calibration processes require a user to manually insert a plate or a sheet of material into the machine at a defined location and orientation. The material is marked with a fiducial pattern of known dimensions. After the calibration is complete, the plate or sheet of material is removed from the machine.

During calibration, markings on the material are measured by a high-resolution scanner (or other device) to determine the position error for each mark in all of the areas of the scan field.

FIG. 7 is a graphical illustration of one calibration template 52 that is consistent with the scanner calibration routine known in the prior art. The calibration template 52 typically is an sheet of material onto which the laser beam is focused. In particular, FIG. 7 depicts commanded mark locations (solid lines) 54 and also actual mark locations (dotted lines) 56 made by a laser beam onto the calibration template 52.

In one prior art example, the calibration template 52 is a sheet of paper with the commanded mark locations 54 printed thereon. The actual mark locations 56 are laser burn marks on the calibration template 52. The burn marks permitted calibration of the laser source by measuring the deviation of the actual mark locations 56 from the commanded mark locations 54.

It is noted that, in other prior art examples, the commanded mark locations 54 do not actually appear on the calibration template 52. Only the actual mark locations 56 are contemplated appear on the calibration template 52 after activation of the laser beam.

As should be apparent to those skilled in the art, the processor that executes the prior art scanner calibration routine understands where the laser beams are supposed to focused on the calibration template (e.g., at the commanded mark locations 54). After scanning the calibration template 52, the locations of the actual mark locations 56 are determined using the scanner.

With the idealized, commanded mark locations 54 understood and the actual locations 56 measured, the X/Y error (i.e., the “drift”) between each point may be input into a calibration algorithm to create a corrected configuration file for the scanner. Sometimes the process may need to be repeated to enable best calibration, but better algorithms allow good calibration to be achieved without iteration. At the conclusion of a successful calibration, the scanner is understood to focus the laser beam at the intended location with only a small amount of error. For a scan field of 500 mm×500 mm, a calibration error <10 μm at any specific location generally is considered “good” or “very good” by the standards considered to be appropriate for the modern 3D printing industry.

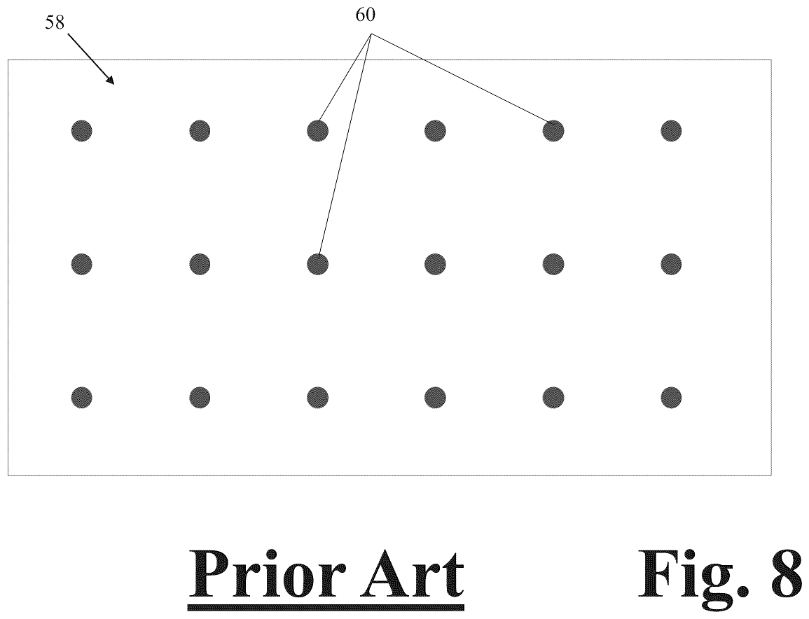

FIG. 8 illustrates a calibration template (also referred to as a “fiducial plate” or a “pre-characterized fiducial plate”) 58 that may be used according to a separate calibration process known to the prior art. As in the example illustrated in FIG. 7, the fiducial plate 58 is temporarily inserted, manually, onto the bed of the printing machine.

In this prior art calibration method, the fiducial plate 58 contains clearly defined (sharp-edged) regions 60 that are significantly co-planar but have contrasting optical characteristics. In the example shown in FIG. 8, the fiducial plate 58 is sand-blasted aluminum while the well-defined dots are pressed-in pieces of optically absorptive material. Alternatively, the fiducial plate 58 may be a single piece of glass with the contrasting regions 60 being provided via frosting and/or coatings. Generally, the method may be optimized if one of the two regions provide a diffuse reflection.

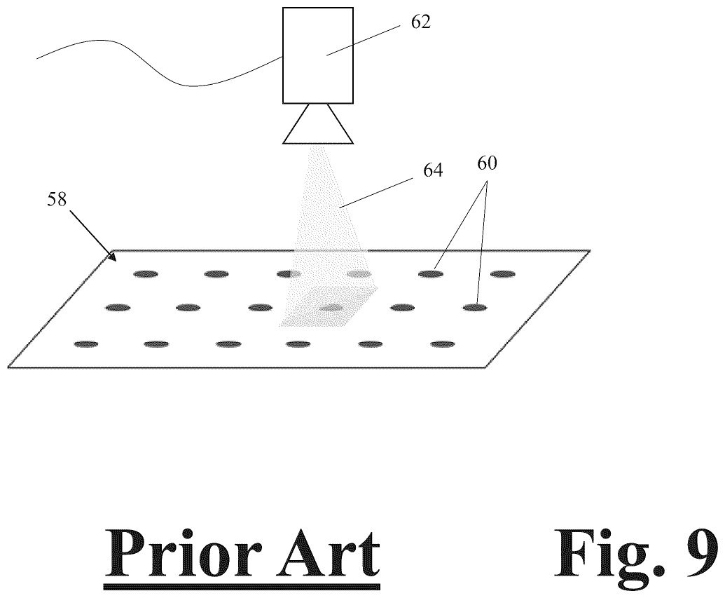

Refence is now made to FIG. 9, which illustrates a photodetector 62 in relation to the fiducial plate 58. FIG. 9 illustrates scanning across fiducial features 60 to enable determination of the features' locations by monitoring the scattered light signal.

The laser and scanner within the machine may be utilized to sweep across the high-contrast features 60 while a wide-view photodetector 62 monitors the scattered light within the build chamber. Either the primary IR beam or visible aiming beam 64 may be used at various power levels that prevent burning, ablating or melting of the fiducial plate 58. Assessment of the rise/fall signal from the photodetector 64 allows the feature location in the scan direction to be understood.

In practice, various prior art methods may be utilized to establish the X/Y location of the feature 60 via an edge detection scheme. The determined location of the feature 60 may be compared to the idealized location to determine the error map that feeds the correction algorithm. Circular features may be generally preferred, but a variety of fiducial shapes may be made to work.

It is noted that, while the prior art provides for specific calibration of prior art printers, as discussed in connection with FIGS. 7-9, the prior art fails to provide any way to calibrate prior art printers in a Z-axis direction. More specifically, the prior art fails to provide a method for calibrating prior art printers that incorporate zoom optics. The present invention addresses at least this deficiency.

Before discussing the method of the present invention, a few conventions and references are provided.

As highlighted in connection with the embodiments discussed hereinbelow, a fiducial pattern is provided within a 3D scanner 10 such that the fiducial pattern is made available for frequent scanning, assessment, and calibration at different magnifications of the zoom optic 29.

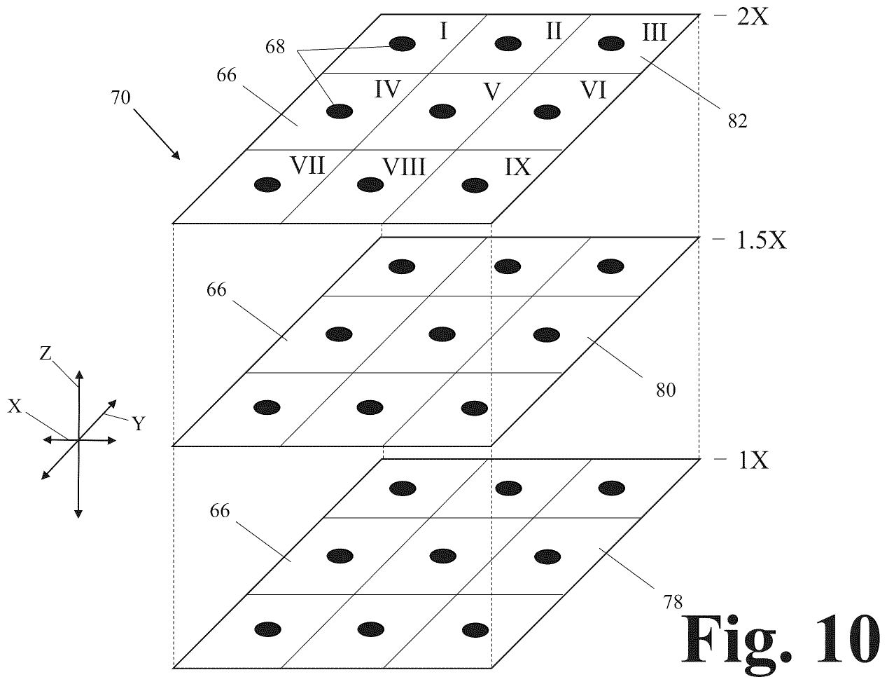

In an embodiment of the present invention, as shown in FIG. 10, a fiducial sheet 66 may be provided that contains fiducial features 68 thereon.

The fiducial sheet 66 may be a flexible sheet, a rigid sheet, or a semi-rigid sheet, as required or as desired. The composition of the fiducial sheet 66 is not limiting of the present invention.

The fiducial features 68 may be printed on or otherwise provided on the fiducial sheet 66 as high contrast features. The manner of the disposition of the fiducial features 68 on the fiducial sheet 66 are not limiting of the present invention.

While the fiducial features 68 are illustrated as circular dots in FIGS. 10-13, it is noted that the fiducial features 68 may have any shape as required or as desired without departing from the scope of the present invention.

Still further, the fiducial features 68 may be arranged as a pattern, such as a grid, without departing from the scope of the present invention.

As discussed hereinabove, the 3D printer 10 of the present invention is contemplated to incorporate zoom optic 29 that may be adjusted to permit magnification of the fiducial features 68 by the scanner 22. The zoom optic 29 also may be used to scan the projected positions of the laser beam 33, 34 on the fiducial sheet 66 in relation to the fiducial features 68.

As an example, with reference to FIG. 10, the zoom optic 29 may be adjusted by the controller 26 to alter the magnification of the scanner 22 from a 1× magnification to a 2× magnification. It is noted that a 1× magnification refers to a lack of magnification (1 times the actual image) (or the actual image itself). A 2× magnification refers to a magnification of two times the actual image.

In FIG. 10, the fiducial sheet 66 is scanned at three separate magnifications: 1×, 1.5×, and 2×. These magnifications are exemplary only and are not intended to limit the scope of the present invention. Contemplated embodiments may include a greater number or a fewer number of magnifications.

As will be made apparent from the discussion that follows, a minimum of two magnifications are required to practice the present invention. In particular, the present invention relies on the data associated with drift of laser impingement locations from the fiducial features at two or more magnifications to calculate (or approximate) drift as the magnification of the zoom optic 29 is changed by the controller 26.

In FIG. 10, it is noted that the same fiducial sheet 66 is used to calibrate the laser source 24 for each of the three magnifications illustrated (1×, 1.5×, and 2×). As a result, the fiducial features 68 are understood to be at the same positions for each of the magnifications that are scanned by the scanner 22.

Since it is contemplated that the 3D printer 10 employs the same fiducial sheet 66 with the same fiducial features 68 for each calibration, irrespective of the magnification level, it is contemplated that the calculation of a function connecting various magnifications with one another will be simplified. In other words, by using the same fiducial sheet 66 for each magnification, the calculations needed to determine any drift for any particular magnification may be made more easily and more quickly.

With continued reference to FIG. 10, when the positions of the fiducial features 68 from two or more fiducial sheets 66 are combined together at two or more magnifications of the zoom optic 29, a 3D calibration matrix 70 is established. Since each of the fiducial features 68 are positioned at the same locations on each of the fiducial sheets 66, all of the fiducial features 66 are in register with one another, regardless of the magnification employed.

In FIG. 10, the X, Y, and Z axes are provided, consistent with the same axes illustrated in FIG. 1. As noted above, the magnification by the zoom optic 29 is illustrated in the Z direction, or along the Z-axis. It is noted that the present invention is not limited solely to this orientation.

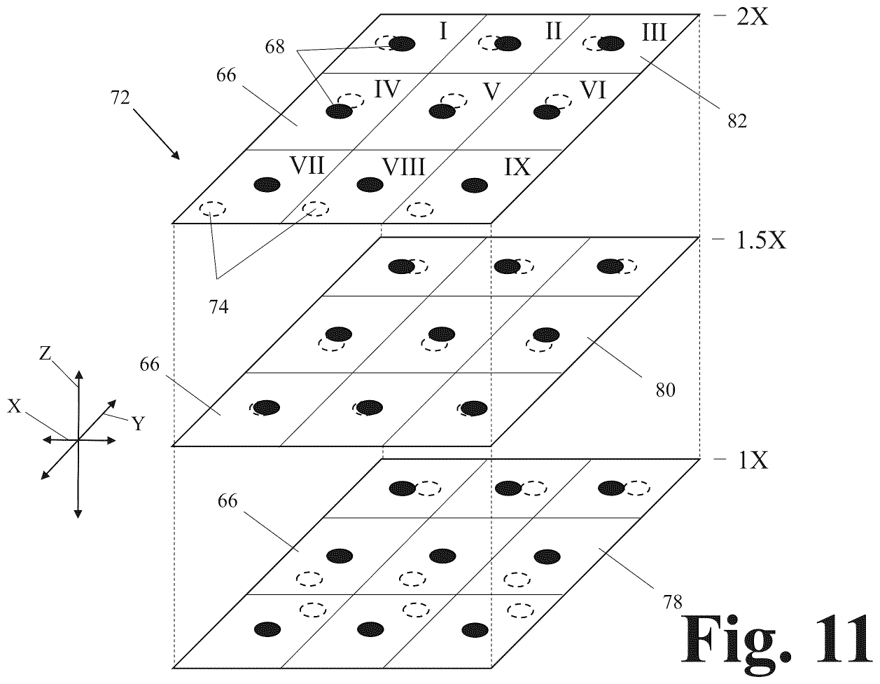

FIG. 11 illustrates a laser projection matrix 72.

The laser projection matrix 72 illustrates the impingement locations 74 where the noninteractive laser beam 33 and/or the interactive laser beam 34 impinges upon the fiducial sheets 66 at the same magnifications identified in FIG. 10. In this figure, the locations of the fiducial features 68 also are provided.

In FIG. 11, the fiducial features 68 are positioned at the same locations as illustrated in FIG. 10. The impingement locations 74, however, have drifted from the ideal locations (i.e., the positions of the fiducial features 68) to the locations illustrated. It is noted that the positions of the impingement locations 74 are selected purely for discussion purposes and, therefore, are not intended to limit the scope of the present invention.

To facilitate the discussion that follows, the following additional definitions and references are provided.

In FIG. 11, the plane containing the fiducial features 68 at a 1× magnification is referred to as the first fiducial plane 78. The plane containing the fiducial features 68 at a 1.5× magnification is referred to as the second fiducial plane 80. The plane containing the fiducial features 68 at a 2× magnification is referred to as the third fiducial plane 82.

In FIGS. 10 and 11, each of the fiducial planes 78, 80, 82 is divided into nine fiducial sectors I, II, III, IV, V, VI, VII, VIII, and IX. Each fiducial sector I, II, III, IV, V, VI, VII, VIII, IX includes one fiducial feature 68. While only the sectors for the third fiducial plane 82 are labeled, the same nomenclature is intended to be applied to the second fiducial plane 80 and the first fiducial plane 78.

It is noted that the identification of the fiducial sectors I, II, III, IV, V, VI, VII, VIII, IX as each containing one fiducial feature 68 is merely by way of example for purposes of discussion. The fiducial sectors I, II, III, IV, V, VI, VII, VIII, IX may include more than one fiducial feature 68 without departing from the scope of the present invention.

With continued reference to FIG. 11, the first fiducial sector I on the first fiducial plane 78 is designated as “78(I).” Similarly, the first fiducial sector I on the second fiducial plane 80 is designated “80(I).” In keeping with this convention, the first fiducial sector I on the third fiducial plane 82 is referred to as “82(I).” This same convention is applied to the remaining fiducial sectors I, II, III, IV, V, VI, VII, VIII, IX.

As illustrated in FIG. 11, the impingement location 74 in fiducial sector 82(IX) is disposed at a distance from the fiducial feature 68 in the same sector. This is intended to indicate that the impingement location 74 for the laser beam 33, 34 has drifted from the fiducial feature 68 within that sector at the 2× magnification. The amount of drift can be designated by measured distances in the X and Y directions, which are consistent with the X-axis and the Y-axis.

When the 3D printer 10 of the present invention is operational, the fiducial sheet 66 is presented to the scanner at various, predetermined magnifications. For the embodiment illustrated in FIG. 11, the three magnifications are 1×, 1.5×, and 2×, as identified above. In the illustrated example, at each magnification, the drift of the impingement 74 location differs for each fiducial plane 78, 80, 82. As should be apparent, there may be a larger or smaller amount of drift than illustrated.

As should be apparent to those skilled in the art, the drift associated with each impingement location 74 is a deviation, in the X-axis direction and/or in the Y-axis direction, from the position of the fiducial feature 68 associated therewith. As noted, in the illustrated example, the impingement locations 74 are associated with the fiducial features in each of the nine sectors I, II, III, IV, V, VI, VII, VIII, and IX.

Before discussing the method 100 of the present invention, it is noted that the three fiducial planes 78, 80, 82 illustrated in FIGS. 10 and 11 are not separate planes arranged in a three dimensional stack. The three fiducial planes 78, 80, 82 are illustrated in a three-dimensional matrix merely to assist with an understanding of the present invention. As should be apparent to those skilled in the art, the fiducial planes 78, 80, 82 are, in reality, the same plane (i.e., the plane of the fiducial sheet 66) but at different magnifications 1×, 1.5×, and 2×.

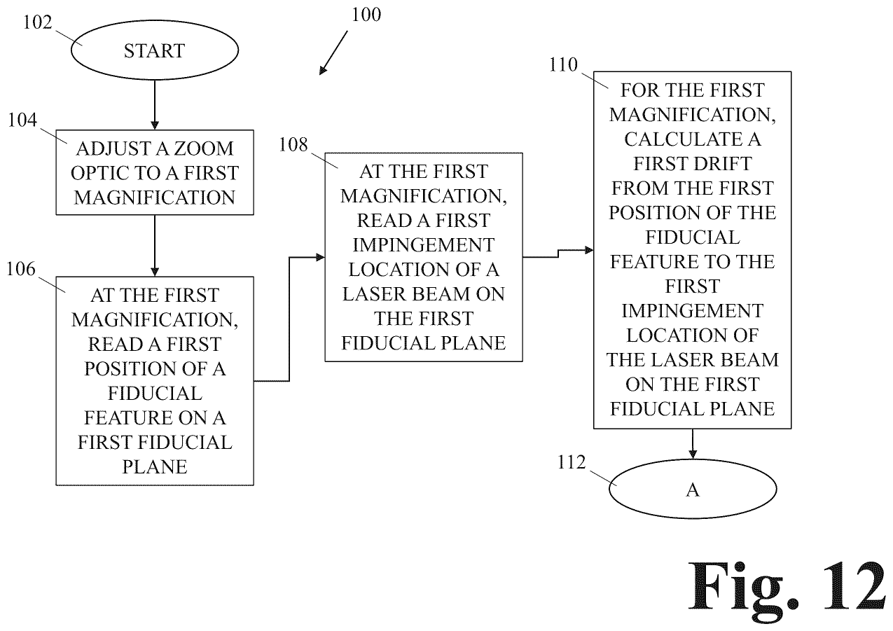

The method of the present invention will now be discussed in connection with FIGS. 12-15, with reference being made to FIGS. 10-11.

The method of calibrating the 3D printer 10 of the present invention across multiple magnifications is referred to as the method 100.

As illustrated in FIG. 12, the method 100 starts at step 102.

From the start at step 102, the method 100 proceeds to step 104 where the zoom optic 29 is adjusted by the controller 26 to a first magnification. For example, with reference to FIG. 10, the zoom optic 29 may be adjusted to 1× magnification. The first magnification of 1× is associated with the first fiducial plane 78.

The method then proceeds to step 106. At step 106, at the first magnification 1×, the scanner 22 reads a first position of a fiducial feature 68 on the first fiducial plane 78. The method 100 then proceeds to step 108.

At step 108, at the first magnification 1×, the scanner 22 reads a first impingement location 74 of a laser beam 33, 34 on the first fiducial plane 78. The method 100 then proceed to step 110.

At step 110, for the first magnification 1×, the controller 26 calculates a first drift that represents a deviation and/or error from the first position of the fiducial feature 68 to the first impingement location 74 of the laser beam 33, 34 in the first fiducial plane 78. With reference to FIG. 11, this may refer to the drift illustrated in, for example, in 78(IX). The “drift” is intended to refer to the deviation of the first impingement location 74 from the location of the first fiducial feature 68 in the X and Y directions of the first fiducial plane 78.

The method 100 then proceeds to the transition node “A” at step 112.

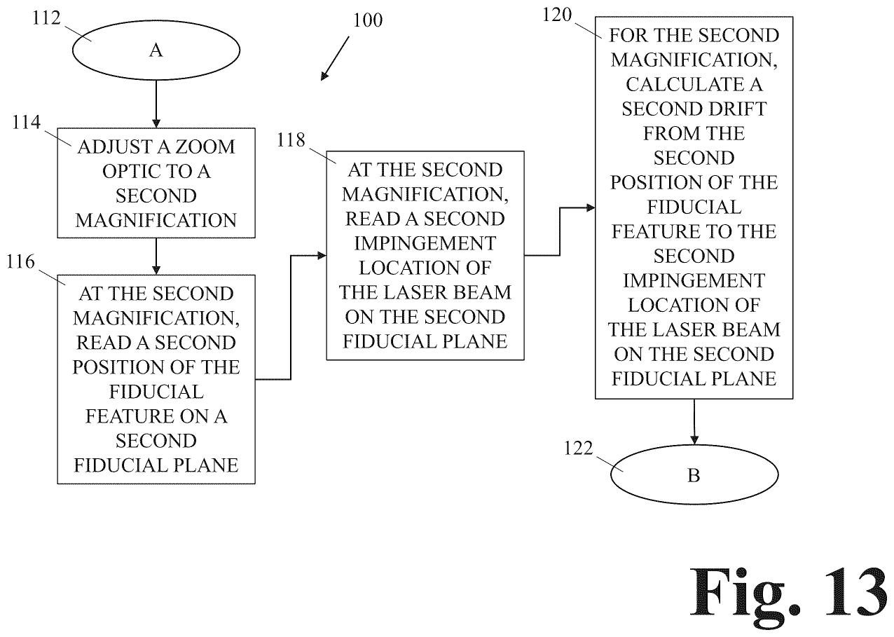

The transition node “A” (step 112) also is illustrated in FIG. 13. The method 100 continues from the transition node “A” (step 112) in FIG. 13.

The method 100 proceeds to step 114, where the zoom optic 29 is adjusted to a second magnification. With reference to FIGS. 10-11, the second magnification may be, for example, 1.5×.

The method then proceeds to step 116. At step 116, at the second magnification 1.5×, a second position of a fiducial feature on the second fiducial plane 80 is scanned. Consistent with prior steps, this scan involves the 80(IX) sector on the second fiducial plane 80.

The method 100 proceeds to step 118. At step 118, which is at the second magnification of 1.5×, the scanner 22 reads a second impingement location 74 of the laser beam 33, 34 on the second fiducial plane 80. Again, for consistency, this refers to the 80(IX) sector.

At step 120, which is the next step in the method 100, for the second magnification of 1.5×, the controller 26 calculates a second drift from the second position of the fiducial feature 68 to the second impingement location 74 of the laser beam 33, 34 on the second fiducial plane 80. Again, this refers to the 80(IX) sector, for this example.

From step 120, the method 100 moves to the transition node 122, labeled “B.”

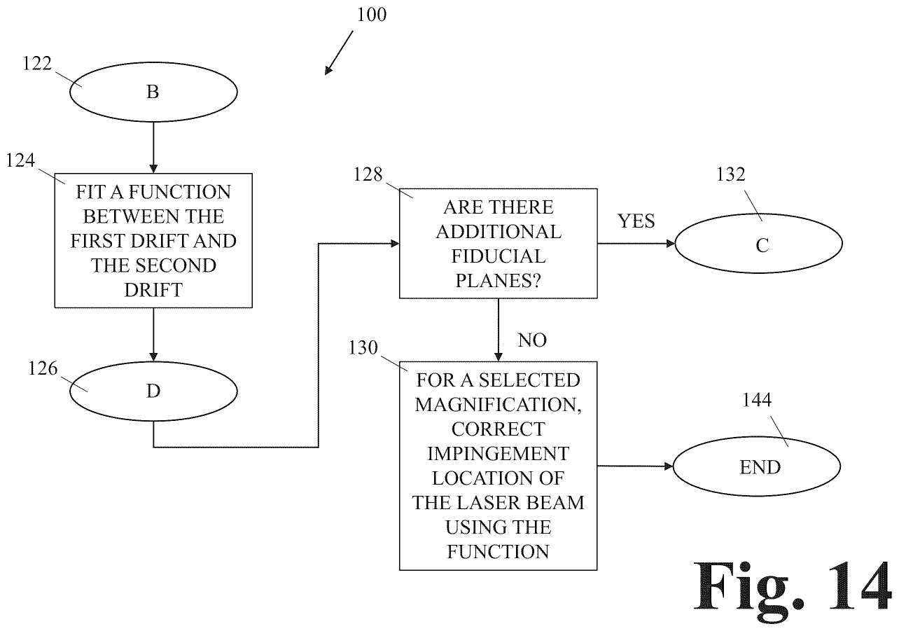

The transition node 122, labeled “B,” indicates that the method 100 continues in FIG. 14.

From the transition node 122, the method 100 continues to step 124 where the controller 26 fits a function between the first drift and the second drift.

As should be apparent to those skilled in the art, the function may be a linear function that maps the first drift to the second drift. Alternatively, the function may be a non-linear function as appropriate. The present invention is not intended to be limited to any particular function, whether linear or not.

The function permits the controller 26 to calculate or approximate a drift for any impingement location 74 at a magnification between the first magnification of 1× and the second magnification of 1.5×. For example, if the controller 26 adjusts the magnification of the zoom optic 29 to 1.25×, the controller 26 is contemplated to employ the function to calculate, and thereby estimate, the drift of the impingement location 74 of the laser beam 33, 34 at the intermediate magnification of 1.25×. Similarly, the function may be used to calculate the drift for any magnification of the zoom optic 29.

As should be apparent from the foregoing, it is contemplated that the function may be the same for all of the sectors I, II, III, IV, V, VI, VII, VIII, IX. Alternatively, there may be different functions for each sector I, II, III, IV, V, VI, VII, VIII, IX.

As noted above, the method of the present invention 100 requires that there be at least two drift points so that the controller 26 may fit the function to the two drift points. The drift points are contemplated to be located on two separate fiducial planes 78, 80, 82, which permits calculation and/or fit of a function to the drifts measured by the scanner 22.

To assess if there are additional drift points that may be taken into account, the method 100 proceeds to step 128, where the method assesses if there are additional fiducial planes 78, 80, 82 to be considered.

If there are only two drift points for calculation of the function, then the method 100 proceeds to step 130 where the method 100 uses the function to correct for the drift by correcting the impingement location 74 of the laser beam 33, 34. Specifically, using the function, the laser beam 33, 34 is directed to the location of the associated fiducial feature 68 or to a location that is near to the associated fiducial feature. Once the function has been used to correct the drift, the method proceed to step 144 where the method ends.

On the other hand, if there are additional drift points to be evaluated by the controller 26, the method 100 proceeds to the transition node 132, labeled “C.”

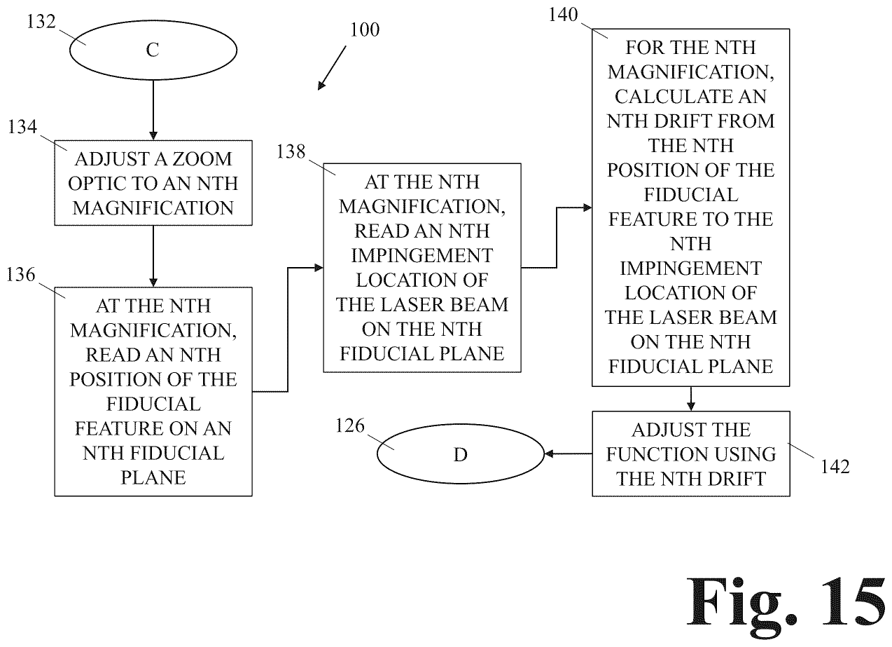

The transition node 132, labeled “C,” continues the method 100 as illustrated in FIG. 15.

The transition node 132 is contemplated to be an iterative node, meaning that the steps associated with this node may be repeated any number of times, as appropriate.

From the transition node 132, the method 100 proceeds to step 134, where the controller 26 adjusts the magnification of the zoom optic 29 to an Nth magnification.

After adjusting the magnification to the Nth magnification, the method 100 proceeds to step 136, where the controller 26 reads the Nth position of the fiducial feature 68 on the Nth fiducial plane. Here, for example, the Nth fiducial plane may be the third fiducial plane 82 illustrated in FIGS. 10 and 11. However, as discussed, any other fiducial plane may be the object of this inquiry.

From step 136, the method proceeds to step 138. At step 138, the magnification is at the Nth magnification. Here, the controller 26 reads an Nth impingement location 74 of the laser beam 33, 34 on the Nth fiducial plane.

The method 100 then proceeds to step 140. At step 140, for the Nth magnification, the controller 26 calculates an Nth drift from the Nth fiducial position 68 to the Nth impingement location 74 of the laser beam 33, 34 on the Nth fiducial plane.

The method 100 then moves to step 142. At step 142, the method 100 adjusts the function using the Nth drift.

With renewed reference to FIG. 11, the Nth drift may be associated with the sector 82(IX) and, therefore, with the third fiducial plane 82. Once the method 100 determines the drift for sector 82(IX), that drift may be used, together with the drifts associated with sectors 78(IX) and 80(IX) to establish a function encompassing all three drifts.

From step 140, the method 100 moves to the transition node 126, labeled “D.”

Transition node 126, with is illustrated in FIG. 14, precedes the inquiry at step 128, which asks if additional fiducial planes need to be taken into account. As before, if all of the fiducial planes have been taken into account for the calculation of the function, the method 100 proceeds to step 144 where the method 100 ends.

The method 100 is described in connection with individual fiducial features 68 on the first fiducial plane 78, on the second fiducial plane 80, and the third fiducial plane 82. These fiducial features 68 are, for example, the fiducial features 68 identified for the sectors 78(IX), 80(IX), and 82(IX). Similarly, the method 100 is described in connection with individual ones of the impingement locations 74 on the first fiducial plane 78, on the second fiducial plane 80, and the third fiducial plane 82. Again, these are for the sectors 78(IX), 80(IX), and 82(IX).

As should be apparent from the foregoing discussion, the method 100 contemplates that the drifts between all of the plurality of fiducial features 68 and the impingement locations 74 will be calculated by the controller 26. With reference to FIGS. 10 and 11, this involves all of sectors I, II, III, IV, V, VI, VII, VIII, and IX.

With this in mind, it is contemplated that a separate function may be calculated by the controller 26 for each of the drifts associated with each of the sectors I, II, III, IV, V, VI, VII, VIII, IX. Moreover, each sector I, II, III, IV, V, VI, VII, VIII, IX may have a different drift function associated therewith.

For clarity, it is noted that the function(s) calculated by the controller 26 that extend between the drifts at various magnifications (i.e., at various fiducial planes 78, 80, 82) may be employed by the controller 26 to calculate and/or estimate the amount of drift at any magnification. For example, if the magnification is set at 1.25×, the controller is contemplated to calculate the drift of the impingement locations 74 using the function(s) fitted to the calibration matrix 70 and/or the laser projection matrix 72.

For further clarity, it is noted that the fiducial features 68 may be virtual in at least one embodiment. In particular, it is contemplated that the scanner 22 will measure the impingement locations 74 of the laser beam 33, 34 on a fiducial plane 78, 80, 82, such as the fiducial sheet 66. It is not required for the fiducial features 68 to be located physically on the fiducial plane 78, 80, 82 or the fiducial sheet 66. Instead, the locations of the fiducial features 68 may be located in a memory included in the controller 26 and/or connected to the controller 26.

Where the fiducial features 68 are virtual, the method 100 compares the locations of the virtual fiducial features 68 to the impingement locations 74 read by the scanner 22. In this contemplated embodiment, the controller 26 and/or the scanner 22 are reading or scanning the locations of the fiducial features 68 from memory. The locations of the fiducial features 68 are, therefore, not “on” the fiducial plane 78, 80, 82, but are associated with the fiducial planes 78, 80, 82.

The present invention is intended to encompass embodiments where the fiducial features 68 are virtual, meaning that they are stored in memory.

It is noted that the present invention also may be applied to embodiments where the zoom optic 29 is replaced with another type of modifying optic. The modifying optic is contemplated to change a parameter associated with the laser beam 33, 34 projected onto the fiducial planes 78, 80, 82. In this contemplated variation, the modifying optic changes one of a shape, a size, an orientation, and/or a color of the laser beam 33, 34 projected onto the fiducial plane 78, 80, 82. Drift may be calculated using the changed parameters from one fiducial plane 78, 80, 82 to another, in the same manner that the change in magnification is employed, as described hereinabove.

It is noted that the controller 26 is contemplated to incorporate one or more processors and/or memory that are employed to execute the method 100. While it is contemplated that the method 100 is embedded in software executed by the controller 26, the method 100 may be hardwired into the controller, in part or in whole, without departing from the scope of the present invention.

As should be apparent from the foregoing, the 3D printer 10 of the present invention encompasses elements of hardware and software. For example, the controller 26 is contemplated to include one or more processors, memory storage, and software components that are executable thereby. The term software is used herein in its commonly understood sense to refer to programs or routines (e.g., subroutines, objects, plug-ins, etc.), as well as data, usable by a machine or processor. As is well known, computer programs generally comprise instructions that are stored in machine-readable or computer-readable storage media. Some embodiments of the present invention may include executable programs or instructions that are stored in machine-readable or computer-readable storage media, such as a digital memory. This is not intended to convey or to imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc., such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

In view of the many possible embodiments to which the principles of the disclosed technology may be applied, it should be recognized that the illustrated embodiments are only preferred examples and should not be taken as limiting the scope of the disclosure. We claim as our invention all that comes within the scope and spirit of the appended claims.

1. A method for calibrating a 3D printer comprising a laser source adapted to generate a laser beam and direct the laser beam to a plurality of impingement locations on a fiducial plane, a plurality of fiducial features presented by the fiducial plane, a scanner adapted to scan the plurality of fiducial features and the plurality of impingement locations on the fiducial plane, a zoom optic adapted to change a magnification of the scanner, and a controller connected to the laser source, the scanner, and the zoom optic, wherein the method comprises:
adjusting, by the controller, the zoom optic to a first magnification;
at the first magnification, by the scanner, reading a first position of a fiducial feature on a first fiducial plane;
at the first magnification, by the scanner, reading a first impingement location of the laser beam on the first fiducial plane;
for the first magnification, calculating, by the controller, a first drift from the first position of the fiducial feature to the first impingement location of the laser beam on the first fiducial plane;
adjusting, by the controller, the zoom optic to a second magnification;
at the second magnification, by the scanner, reading a second position of a fiducial feature on a second fiducial plane;
at the second magnification, by the scanner, reading a second impingement location of the laser beam on the second fiducial plane; and
for the second magnification, calculating, by the controller, a second drift from the second position of the fiducial feature to the second impingement location of the laser beam on the second fiducial plane.

2. The method according to claim 1, further comprising:
fitting, by the controller, a function between the first drift and the second drift.

3. The method according to claim 1, further comprising:
for the first magnification, calculating, by the controller, the first drift for each first impingement location from the plurality of impingement locations; and
for the second magnification, calculating, by the controller, the second drift for each second impingement location from the plurality of impingement locations.

4. The method according to claim 3, further comprising:
fitting, by the controller, a function between the first drift and the second drift for each impingement location from the plurality of impingement locations.

5. The method according to claim 1, further comprising:
assessing, by the controller, if there is an Nth fiducial plane in addition to the first fiducial plane and the second fiducial plane;
adjusting, by the controller, the zoom optic to an Nth magnification;
at the Nth magnification, by the scanner, reading an Nth position of a fiducial feature on an Nth fiducial plane;
at the Nth magnification, by the scanner, reading an Nth impingement location of the laser beam on the Nth fiducial plane; and
for the Nth magnification, calculating, by the controller, an Nth drift from the Nth position of the first fiducial feature to the Nth impingement location of the laser beam on the Nth fiducial plane.

6. The method according to claim 5, further comprising:
fitting, by the controller, a function between the first drift, the second drift, and the Nth drift.

7. The method according to claim 5, further comprising:
for the first magnification, calculating, by the controller, the first drift for each first impingement location from the plurality of impingement locations;
for the second magnification, calculating, by the controller, the second drift for each second impingement location from the plurality of impingement locations; and
for the Nth magnification, calculating, by the controller, the Nth drift for each Nth impingement location from the plurality of impingement locations.

8. The method of claim 7, further comprising:
fitting, by the controller, a function between the first drift, the second drift, and the Nth drift for each impingement location from the plurality of impingement locations.

9. The method of claim 1, wherein the magnification is between 1× and 3×.
